(19) United States
(12) Patent Application Publication
(10) Pub. No.: US 2025/0317102 A1
(43) Pub. Date: Oct. 9, 2025

(54) SOLAR POWER PORTABLE CELL

(71) Applicant: Government of the United States as represented by the Secretary of the Air Force, Wright-Patterson AFB, OH (US)

(72) Inventor: Steven Pyott, Elizabeth, AR (US)

(21) Appl. No.: 19/083,960

(22) Filed: Mar. 19, 2025

Related U.S. Application Data
(60) Provisional application No. 63/631,629, filed on Apr. 9, 2024.

(51) Int. Cl. H02S 40/32; H02S 30/00; H02S 40/38

(52) U.S. Cl. CPC H02S 40/32; H02S 30/00; H02S 40/38

(57) ABSTRACT

A solar power portable cell system (SPPC) including: a case; a battery; an AC input charge connection for receiving an AC input charge; an AC charge controller for receiving the AC input charge from the AC input charge connection and converting the AC input charge to a DC charge for outputting the DC charge to the battery; a maximum power point tracking (MPPT) charge controller for receiving a solar electrical charge from at least one solar panel and converting the received solar electrical charge to a DC charge for outputting the DC charge to the battery; at least one DC output charge capable of charging one or more external or internal devices using the DC output charge; and an inverter for converting an output DC charge from the battery to an output AC charge.

### CROSS REFERENCE TO RELATED APPLICATION

Pursuant to 37 C.F.R. § 1.78(a)(4), this application claims the benefit of and priority to prior filed co-pending Provisional Application Ser. No. 63/631,629, filed Apr. 9, 2024, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to solar power cells and, more particularly, to solar power portable cells installed in kits transportable by aircraft.

### BACKGROUND OF THE INVENTION

There can be a critical need for reliable power production in austere environments. In regions where access to conventional power sources is limited or entirely absent, such as remote military bases, disaster-stricken areas, or off-grid locations, essential solutions for continuous and stable power may go unsatisfied. Solar energy may provide eco-friendly, sustainable means of generating electricity, ensuring that essential equipment can function and maintain operations regardless of the local infrastructure.

Moreover, options for transporting current systems to and from such austere locations may be limited or non-existent. For example, there is currently not a lightweight, compact, and robust solution to a need for portable electrical generation. Freight of existing systems via aircraft may provide particular challenges. For instance, existing systems may be prohibited on flights due to risks associated with overheating, fire, or even explosions. Accordingly, there may be a need for portable charging systems that can perform whether deployed in military operations, humanitarian missions, or emergency response efforts in a wide variety of conditions.

### SUMMARY OF THE INVENTION

The present invention overcomes the foregoing problems and other shortcomings, drawbacks, and challenges of current solar power portable cell systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention a solar power portable cell system (SPPC) includes a case; a battery; an AC input charge connection for receiving an AC input charge; an AC charge controller for receiving the AC input charge from the AC input charge connection and converting the AC input charge to a DC charge for outputting the DC charge to the battery; a maximum power point tracking (MPPT) charge controller for receiving a solar electrical charge from at least one solar panel and converting the received solar electrical charge to a DC charge for outputting the DC charge to the battery; at least one DC output charge capable of charging one or more external or internal devices using the DC output charge; and an inverter for converting an output DC charge from the battery to an output AC charge.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows a solar power portable cell (SPPC) system according to one or more embodiments shown and described herein.

FIG. 2 shows additional aspects of the SPPC system of FIG. 1.

FIG. 3 shows an electrical schematic of the SPPC system of FIG. 1.

FIG. 4 shows additional aspects of the SPPC system of FIG. 1.

FIG. 5 shows additional aspects of the SPPC system of FIG. 1.

FIG. 6 shows additional aspects of the SPPC system of FIG. 1.

FIG. 7 shows additional aspects of the SPPC system of FIG. 1.

FIG. 8 shows additional aspects of the SPPC system of FIG. 1.

FIG. 9 shows additional aspects of the SPPC system of FIG. 1.

FIG. 10 shows additional aspects of the SPPC system of FIG. 1.

FIG. 11 shows additional aspects of the SPPC system of FIG. 1.

FIG. 12 shows additional aspects of the SPPC system of FIG. 1.

FIG. 13 shows additional aspects of the SPPC system of FIG. 1.

FIG. 14 shows additional aspects of the SPPC system of FIG. 1.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

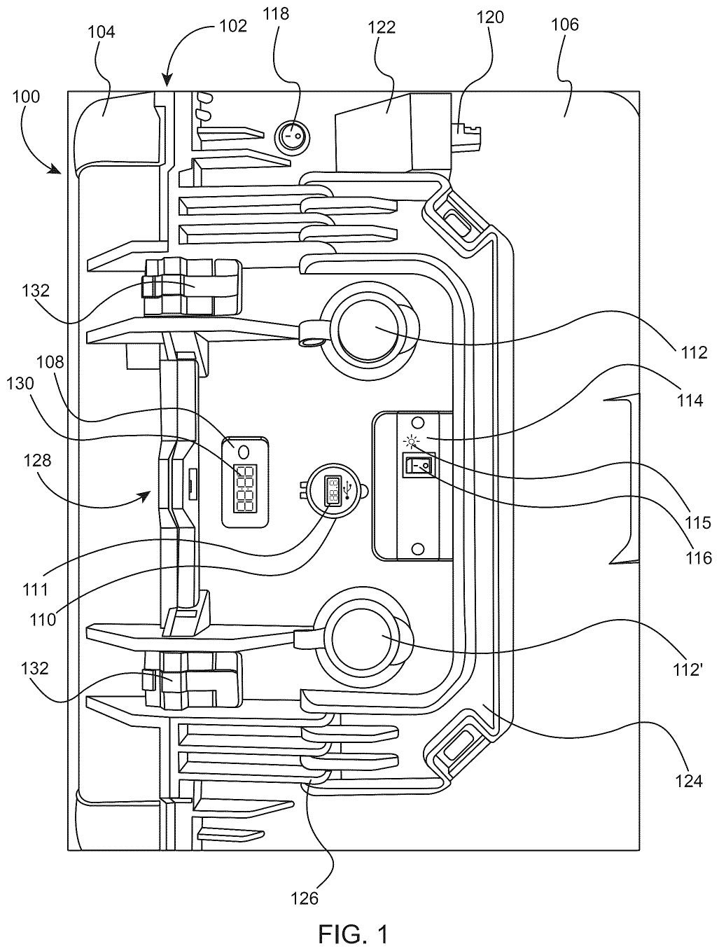

Referring to FIG. 1, an external view of a solar power portable cell (SPPC) system 100 is shown. The SPPC system 100 includes a case 102, with a top portion 104 and a bottom portion 106, a status monitor 108 including a display 130, a DC charge adaptor 110 including a display 111, one or more AC charge adaptors 112, 112′, and an inverter panel 114 including an indication light 115 and an inverter on/off switch 116. The SPPC system 100 may include a solar input switch 118, a solar input 120, and a solar input cover 122. In embodiments, the case 102 of the solar power portable cell 100 may include a handle 124 that may moveably couple to the case 102 at a hinge 126. The case 102 may include a lock portion 128 and one or more fasteners 132.

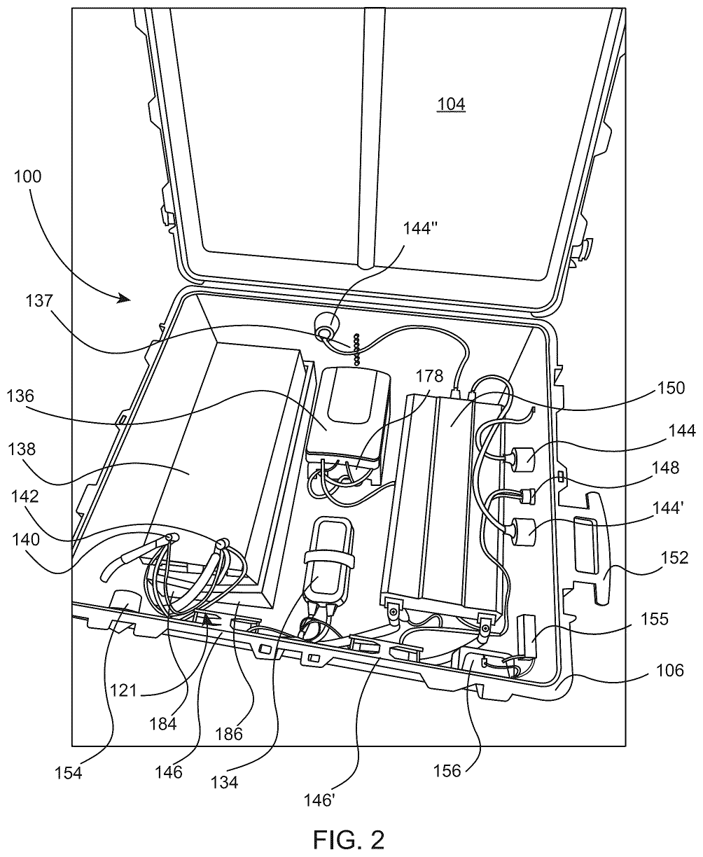

FIG. 2 shows additional details of the SPPC system 100. In FIG. 2, the top portion 104 is raised showing a retention strap 105 and an inside of the bottom portion 106. The retention strap 105 can be used to retain a solar panel (not shown) or other object or feature of the SPPC system 100. The SPPC system 100 includes a charge controller 134, a maximum power point tracking charge controller (MPPT) 136, which may be positioned in the case 102 on a MPPT platform 178, a power store 138 (e.g., a lithium ion battery, a lead acid battery, etc.) including a positive connection 140 and a negative connection 142, an inverter 150, a fuse block 156, a fan controller 155 for controlling a one or more fans 146, 146′, an LED panel 137, an AC input charge connection 154, one or more AC charge connections 144, 144′, 144″ for providing an AC electrical charge to one or more external devices, and a DC charge connection 148 for providing a DC electrical charge to one or more external devices. In embodiments, the lower portion 106 may include a handle 152. The power store 138 may be housed in the case 102 using a battery tray 121. In some embodiments, the battery tray 121 can be a two-piece battery tray including a first part 184 and a second part 186.

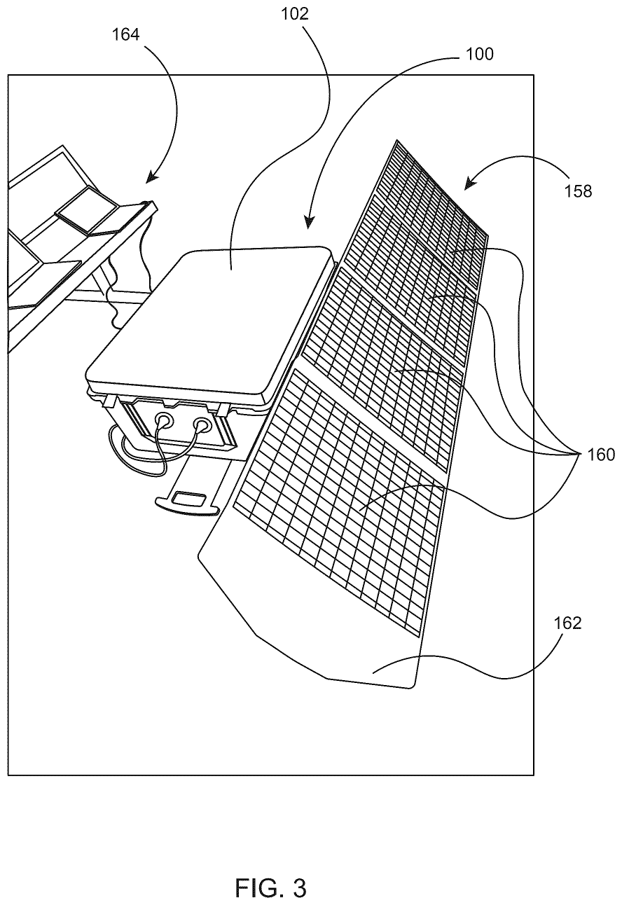

Referring to FIG. 3, a solar panel system 158 including a solar panel 162 with multiple panel cells 160 is shown. The solar panel system 158 may be electrically coupled with the SPPC system 100 in the case 102. The SPPC system 100 may be coupled to provide power from the power store 138 (not shown) inside the case 102 to power one or more devices, such as, for example, a laptop 164. The case 102 may further include a seal 168 for allowing air to escape the case 102 but which may prevent air from reentering through the seal.

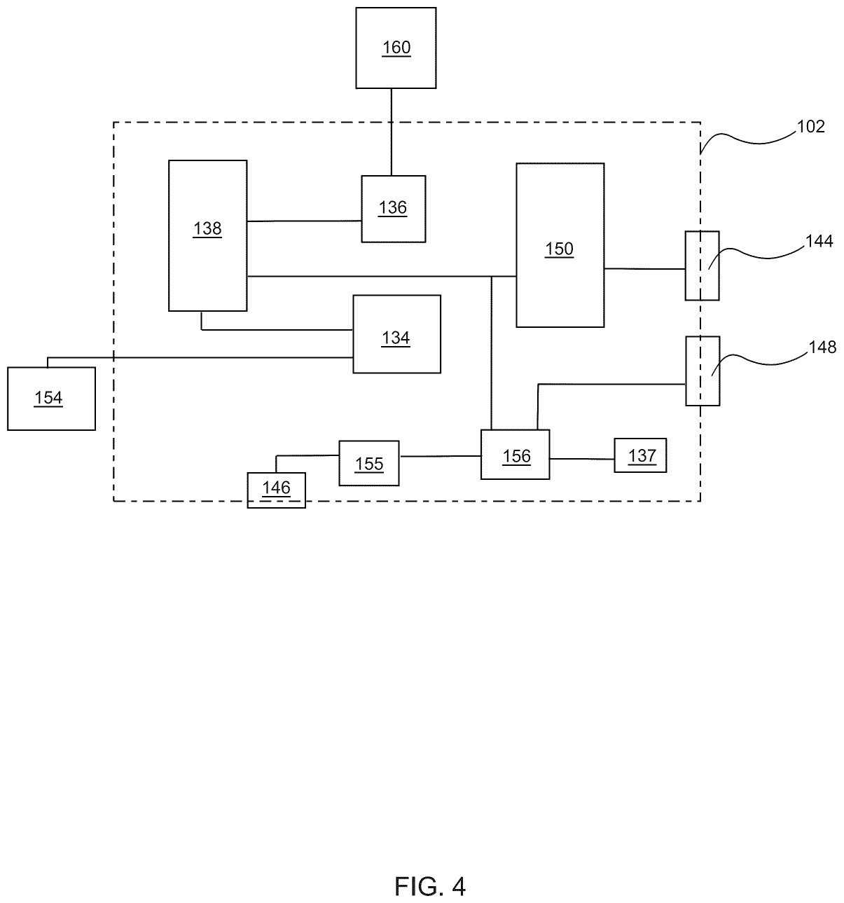

FIG. 4 shows an electrical schematic of the SPPC system 100 including many of the features shown in FIGS. 1, 2, and 3. The SPPC system 100 may be configured to receive an AC electrical charge from one or more of the AC input charge connection 154 and the solar panel cells 160. The AC electrical charge may be used to charge the power store 138 via one or more of the charge controller 134 and the MPPT 136. The charge controller 134 can receive either a 110 V, 60 Hz AC signal or a 230 V, 50 Hz signal and convert the AC signal to a DC signal to charge the power store 138. In turn, the power store 138 can provide a DC charge to the inverter 150 to generate an AC electrical charge for charging one or more devices and/or systems via the one or more AC charge connections 144. Additionally, the power store 138 can provide a DC electrical charge to the fuse block 156 for powering the fan controller 155, the DC charge connection 148, and/or the LED panel 137.

The various components of the SPPC system 100 shown in FIG. 1, FIG. 2, FIG. 3, and FIG. 4 will now be described in greater detail with reference to these figures.

The DC charge adaptor 110 may provide for the DC charge connection 148 to charge one or more devices with a direct current. In some embodiments, the DC charge connection 148 may be coupled with the fuse block 156. The fuse block 156 may help manage the distribution of power from the DC source. In some embodiments, the fuse block 156 is a 12 V fuse block (e.g., in embodiments in which the power store 138 is a 12 V battery) and may cut of power flow in the event of a short circuit to protect any devices connected to the SPPC system 100 and wiring. In some embodiments, the SPPC system 100 may include a DC charger for converting a DC signal from one voltage to another (e.g., from 12 V to another voltage via buck or boost converter). The DC charge adaptor 110 may include various connection types (adaptors). For example, the DC charge adaptor 110 can include an outlet, one or more USB ports, etc. In some embodiments, the system may charge via regulated charging such that the voltage and current output are consistent.

The AC charge adaptors 112, 112′ may be adaptors for connecting one or more external devices to the system via the AC charge connections 144, 144′, 144″ and the inverter 150. The inverter 150 may receive a DC electrical signal from the power store 138 and may invert the DC signal to an AC signal for providing AC power to various devices through the AC charge adaptors 112, 112′. In some embodiments, the inverter 150 may be powered on or off via the switch 116 on the inverter panel 114. The indication light 115 on the inverter panel 114 provides a user a convenient indication of the status of the inverter 150. The inverter 150 may use one or more transistors, IGBTs, MOSFETs, or other switching devices to alternate a polarity of the AC signal. The inverter 150 can have different capacities depending on the specifications of the system. For example, the inverter 150 may be a 3000W inverter, a 2000 W inverter, a 4000 W inverter, etc. The inverter 150 can be either a pure sine waver inverter, a modified sine wave inverter, or a square wave inverter. The inverter 150 may produce an output with any frequency including, for example, 50 Hz, 60 Hz, etc., and may have any efficiency rating. In some embodiments, the inverter 150 may be a smart inverter, which may, for example, communicate with a power grid or other device to optimize energy production, consumption, and storage. In such embodiments, the system may monitor for faults and adjust settings to improve efficiency and/or safety.

The solar panels 160 may generate a DC signal by converting sunlight to electrical energy. The voltage and current of each panel may depend on the amount of sunlight the particular panel receives and its specifications. The solar panels 160 may be connected in series or parallel. The MPPT 136 may receive the solar electrical charge from the solar panels 160 and may ensure the solar panels 160 operate at their maximum power output, adjusting an operating point of the panels to achieve a high efficiency. The MPPT 136 may continuously monitor a power output of the solar panels 160 and adjust an input voltage and current to match the requirements of the power store 138. The MPPT 136 may regulate battery input voltage and current to the power store 138 to avoid overcharging and protect it from damage. In some embodiments, the potential of the DC signal generated by the solar panels 160 may be higher than that of the power store 138. The MPPT 136 may stop down the higher voltage to a suitable voltage for charging. Once the power store 138 is at its proper voltage, the MPPT 136 may reduce or stop charging to prevent overcharging. In some embodiments, the MPPT 136 may be a smart MPPT that recognizes a loading schedule on the power store 138 and maximizes an overall efficiency with respect to the loading schedule. For instance, in some embodiments, one or more devices may be electrically coupled to the SPPC system 100 on a routine schedule and hence the electrical draw may be routinely higher at these times. The smart MPPT could recognize when this occurs and plan the solar charging of the power store 138 accordingly. The MPPT 136 may couple to the solar panels 160 via the solar input switch 118. In some embodiments, the top portion 104 of the case may serve as a storage location for one or more solar panels 160 when the solar panels 160 are not in use.

The charge controller 134 may manage the charging of the power store 138 with AC from an external connection (e.g., via a grid connection through the AC input charge connection 154). The controller ensures that the power store 138 receives the correct voltage and current, preventing overcharging and damage to the power store 138. The charge controller 134 rectifies the external AC signal into DC power via a rectifier and monitors a voltage and state of charge (SOC) of the power store 138. Based on the characteristics of the power store 138 and the incoming AC signal, the charge controller 134 may adjust an amount of current supplied to the power store 138. When the power store 138 is fully charged, the charge controller 134 may block further charging. In some embodiments, the charge controller 134 may be capable of intelligently commencing an external AC charge based on, for example, a status of the MPPT 136. For example, if the MPPT 136 detects a sufficient level of current from the solar panels 160, the charge controller 134 may prevent or stop charging the power store 138 with external AC current because the solar panels 160 can provide sufficient charge. The charge controller 134 may exhibit or incorporate various features or characteristics such as, for example, automatic voltage regulation, multi-stage charging, battery type compatibility, an energy manage system, and power flow control (i.e., the ability to switch between different power sources based on availability, load, or preset configurations).

The power store 138 may incorporate one or more battery cells of one or more types. For example, the power store 138 may be a lead-acid (e.g., PbSO₄), lithium ion (Li-ion), lithium iron phosphate (LiFePO₄), Lithium Polymer (LiPo) or other type of batter(ies). The power store 138 is a rechargeable battery that can be charged and discharged as described herein. The power store 138 can be of any voltage, for instance, 12 V, 24 V, etc.

The fuse block 156 may incorporate one or more fuses and may receive a DC signal from the power store 138 for each of the fuses and distribute power to the various DC-powered aspects of the system through the fuses. The fuses may be rated based on a capacity of the power store 138 and may prevent excessive current flowing to any of the various devices receiving electrical power from the power store 138, for example, the fans 146, 146′.

The one or more fans 146, 146′ may be controlled by the fan controller 155. The one or more fans 146, 146′ may power on to cool the electronics in the interior of the case 102. The fan controller 155 may receive a DC signal from the power store 138 via the fuse block 156 to power the fans 146, 146′.

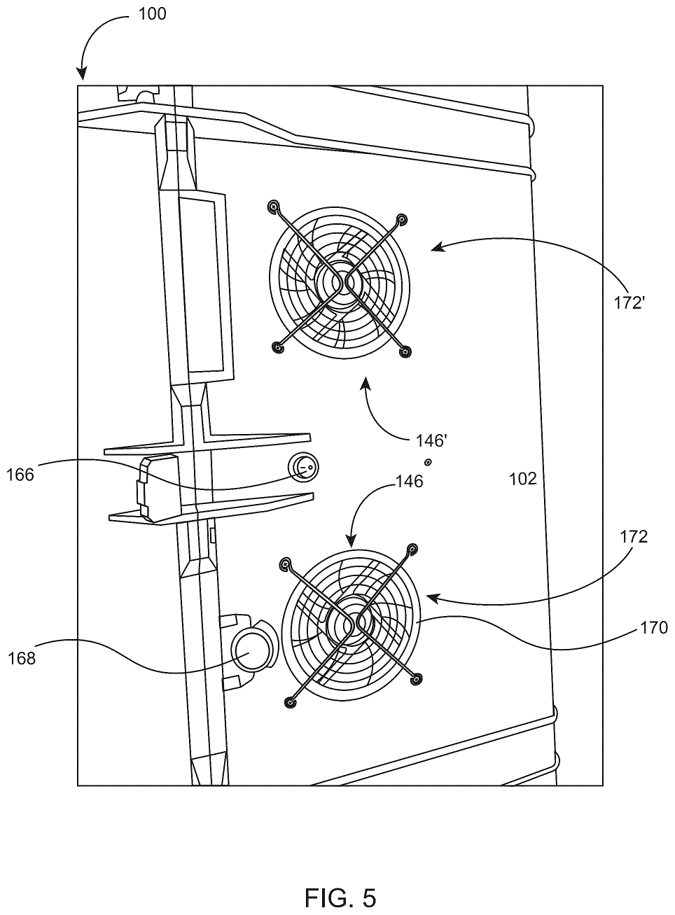

FIG. 5 shows additional features of the SPPC system 100. In one or more walls of the case 102, there may be through holes, such as through hole 172, 172′, for allowing air to pass through the case 102 to cool the electronic equipment inside. In embodiments, air may be forced through the through holes 172, 172′ by one or more fans 146, 146′. The fans 146, 146′ may be controlled by the fan controller (not depicted in FIG. 5) as discussed above using a switch 166. In some embodiments, the through holes 172, 172′ may include a guard 170 or other device to prevent debris and other objects from entering the case 102.

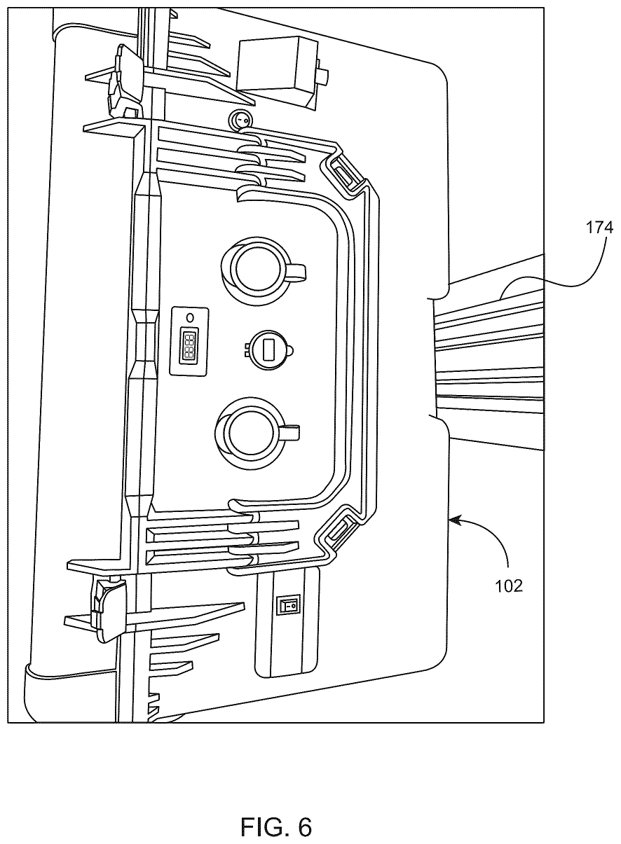

FIG. 6 shows the case 102 with a handle 174 in an extended position. The handle 174 may extend in order to better maneuver the case 102.

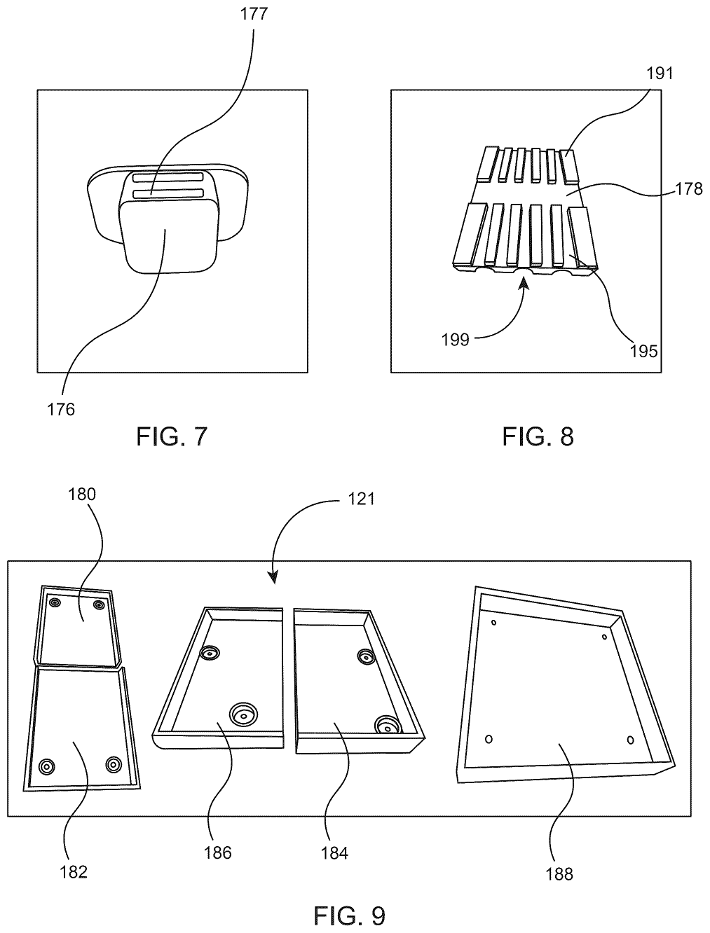

FIG. 7 shows a fuse holder 176. In embodiments, the fuse holder 176 may be a 3D printed Thermoplastic Polyurethane (TPU) 12 v fuse holder. In embodiments, the fuse holder 176 may be rubberized to provide shock absorption such that it can withstand various scenarios, for example, a 5-foot drop. The fuse holder 176 may have one or more slots 177 that provide space for storing one or more fuses (e.g., a 12 V fuse).

FIG. 8 shows a more detailed representation of the MPPT platform 178. The MPPT platform 178 may be, for example, a 3D printed TPU platform. The MPPT platform 178 may have ridges 191 and channels 195. The MPPT of FIG. 2 may rest on the ridges 191 such that air can flow through the channels 195 over a bottom surface of the MPPT to remove heat from the MPPT as it operates in the case. The MPPT platform 178 may also have chord management channels 199 on its bottom side. The chord management channels 199 may provide space for electrical cords or other objects to pass beneath the MPPT platform 178 improving the organization within the case 102.

FIG. 9 shows various battery trays for storing a battery (e.g., the power store 138 (not shown) in the case 102 (not shown)). The battery tray 121 is a two-piece battery tray that includes a first piece 184 and a second piece 186. Similarly, a two-piece battery tray can be arranged such that the two pieces split along a horizontal line, such as the first piece 180 and the second piece 182. FIG. 9 also shows a one-piece battery tray 188. In each instance, the trays can be bolted to the case 102 (not shown) and the power store 138 can be removably coupled to the tray (e.g., via strap).

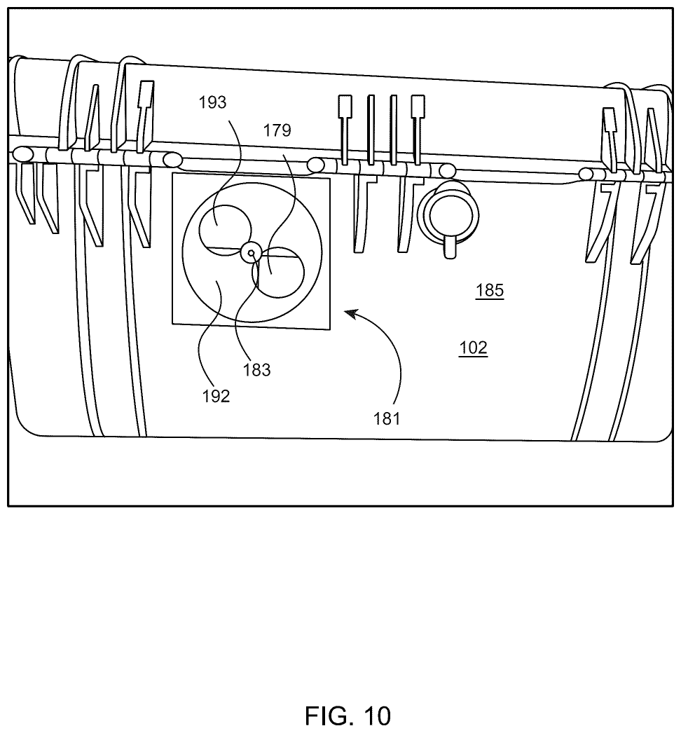

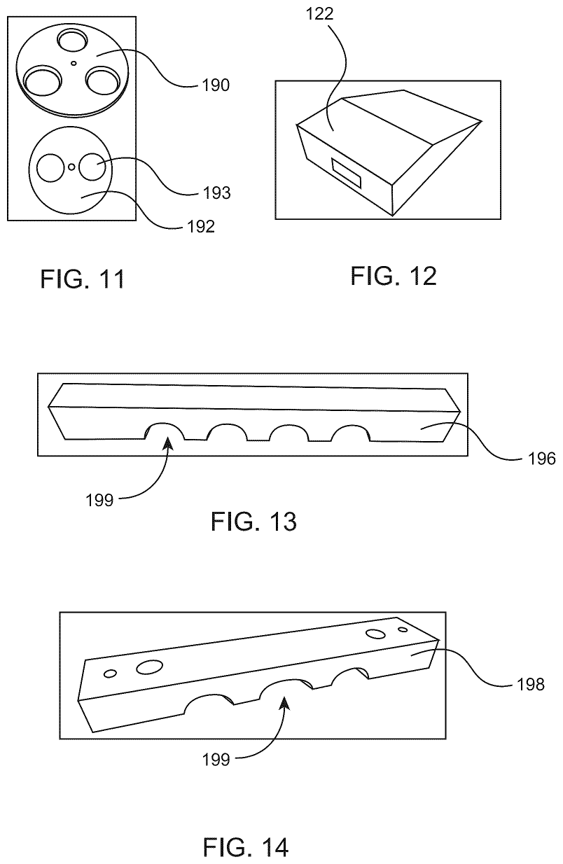

FIG. 10 shows the case 102 and a vent 181 for venting an interior of the case. The vent 181 may include a vent cover 192 that can rotate about an axis 183 opening and closing holes 179 through a wall 185 of the case 102. Referring to FIGS. 10 and 11, the vent 181 can be covered by the vent cover 192. Various embodiments of a cover can be used to close any number of openings in the wall 185. For example, the vent cover 192 has two openings 193 that selectively cover the holes 179. Other embodiments can have more holes and more openings. The holes and openings in the various vents can allow a user to vent the cavity of the case 102 to cool the heat-generating electronics in the interior of the case 102. Vent cover 190 is an alternative embodiment, similar to the vent cover 192. In embodiments utilizing the vent cover 190, the case 102 would have three holes corresponding to the openings in the vent cover 190.

FIG. 12 shows the solar input cover 122 of FIG. 1 in greater detail. The solar input cover 122 protects the integrity of the solar input switch, for example, from debris and other substances that may contact the switch. FIGS. 13 and 14 show a first inverter bracket 196 and a second inverter bracket 198. The inverter brackets 196, 198 can hold the inverter 150, providing a platform for securing the inverter 150 within the case 102 (not shown here). The first inverter bracket 196 and the second inverter bracket 198 may be 3D printed TPU rubberized inverter brackets. The inverter brackets may include chord management channels 199 for managing chords within the case.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A solar power portable cell system (SPPC) comprising:
a case;
a battery;
an AC input charge connection for receiving an AC input charge;
an AC charge controller for receiving the AC input charge from the AC input charge connection and converting the AC input charge to a DC charge for outputting the DC charge to the battery;
a maximum power point tracking (MPPT) charge controller for receiving a solar electrical charge from at least one solar panel and converting the received solar electrical charge to a DC charge for outputting the DC charge to the battery;
at least one DC output charge capable of charging one or more external or internal devices using the DC output charge; and
an inverter for converting an output DC charge from the battery to an output AC charge.

2. The SPPC system of claim 1, wherein the battery is fastened in the case using a two-part battery tray that permanently couples to a lower portion of the case.

3. The SPPC system of claim 2, wherein the MPPT charge controller is fastened in the case using a MPPT platform.

4. The SPPC system of claim 1, wherein the battery is fastened in the case using a single-part battery tray.

5. The SPPC system of claim 1, wherein the battery is a 12V battery.

6. The SPPC system of claim 1, wherein the system comprises four solar panels.

7. The SPPC system of claim 1, wherein the case is configured to hold the at least one solar panel in the case when the solar panel is not in use.

8. The SPPC system of claim 1, wherein the battery is a Lithium Iron Phosphate (LIFEPO₄) battery.
